(19) United States
(12) Patent Application Publication
(10) Pub. No.: US 2024/0110083 A1
(43) Pub. Date: Apr. 4, 2024

(54) DIMENSIONALLY STABLE ADHESIVE COMPOSITION CONTAINING ENZYMATICALLY MODIFIED STARCH

(71) Applicant: Henkel AG & Co. KGaA, Duesseldorf (DE)

(72) Inventors: Benjamin Schroeder, Duesseldorf (DE); Nils Hellwig, Krefeld (DE); Anna Kaulisch, Langenfeld (DE); Ivonne Zickuhr, Korschenbroich (DE)

(21) Appl. No.: 18/537,668

(22) Filed: Dec. 12, 2023

Related U.S. Application Data
(63) Continuation of application No. PCT/EP2022/064190, filed on May 25, 2022.

(30) Foreign Application Priority Data
Jun. 8, 2021 (EP) 21178332.9

(51) Int. Cl. C09J 103/02; C09J 9/00; C09J 11/06

(52) U.S. Cl. CPC C09J 103/02; C09J 9/005; C09J 11/06; C08K 5/09; C09J 2400/20; C09J 2403/00

(57) ABSTRACT

The present invention relates to a dimensionally stable adhesive composition comprising enzymatically modified starch, and to the use of the adhesive composition as a glue stick.

The present invention relates to a dimensionally stable adhesive composition comprising enzymatically modified starch, and to the use of the adhesive composition as a glue stick.

Glue sticks are generally known as a cylinder filled with adhesive in semi-solid form, the content of which cylinder can be pushed out and pulled back in at the end of a stick by rotating a mechanism functioning according to the principle of screwing. The first glue stick was introduced onto the market in 1969, wherein extensive efforts have since been made to replace the initially used oil-based adhesives with more sustainable alternatives.

DE 1811466 describes a glue stick consisting of a shaping builder which is formed from a gel of alkali salts or ammonium salts of aliphatic carboxylic acids having 8 to 36 carbon atoms in water and/or water-miscible organic solvents, and known water-soluble or water-dispersible adhesives as an adhesive component.

WO 03/029376 relates to a dimensionally stable, soft-abradable glue stick made of an aqueous preparation of a synthetic polymer and a soap gel as a builder component, wherein the aqueous preparation of the synthetic polymer contains an at least largely solvent-free aqueous polyacrylate dispersion or a solid alkaline-soluble polyacrylate which both have free acid groups.

WO 2014/019001 discloses a glue stick made of an aqueous preparation of an acrylic acid ester copolymer as an adhesive component and a soap gel as a builder substance, sodium salts of C₁₂ to C₂₂ fatty acids, in particular C₁₄ to C₁₈ fatty acids, being included as the gel structure-forming soap, and wherein the acrylic acid ester has an acrylic acid content of 10-25%.

The disadvantage of the glue sticks described in the prior art is that they continue to depend on petrochemical components. A further approach to forming glue sticks on the basis of renewable raw materials is the use of starch.

DE 19908560 describes a dimensionally stable, soft-abradable glue stick consisting of an aqueous preparation of starch ethers and sucrose as an adhesive component and a soap gel as a shaping builder structure.

EP 2455436 discloses a highly homogeneous adhesive composition comprising enzymatically branched starch having a viscosity stability index SI of less than or equal to 1.3, determined by the quotient of the viscosity after 14 days and the viscosity after 2 hours following production of the composition.

WO 2012/110594 relates to a glue stick containing an aqueous preparation of at least one hydroxyalkyl-carboxymethyl starch having a viscosity of less than 2,000,000 mPas, determined as 40 wt. % aqueous solution by means of a Brookfield RTV viscometer at 20° C., spindle 7, 20 rpm, and soap, and its production and use for the planar bonding of substrates, in particular for bonding paper, cardboard, wood, and/or plastics.

WO 2014/200344 describes an aqueous adhesive composition comprising highly branched starch (HBS), which is obtained by reacting a starch or a starch derivative with a glycogen branching enzyme (EC 2.4.1.18), and a carboxymethyl (CM) polysaccharide derivative.

The glue sticks based on starch that are available in the prior art also have the disadvantage that they continue to have constituents which go back to fossil resources and cannot be obtained at all, or can be obtained only partially, from renewable vegetable raw materials. There is therefore still the need for sustainable compositions which can be used as glue sticks. It is therefore the object of the present invention to provide a dimensionally stable adhesive composition in which the chemically modified starches conventionally used are replaced by alternatively broken down starches, wherein it must be ensured that such adhesive compositions have high bond strength and dimensional stability as well as good abrasion resistance.

It has surprisingly been found that this object is achieved by a water-based, dimensionally stable adhesive composition as defined in claim 1. Preferred embodiments are described in the dependent claims.

The present invention therefore first relates to a water-based, dimensionally stable adhesive composition containing, in each case based on the total weight of the adhesive composition,
a) at least 10 wt. % broken down and enzymatically modified starch having a dynamic viscosity of less than 500,000 mPas, measured according to Brookfield and obtainable by modifying native starch by means of a glycogen branching enzyme (EC 2.4.1.18);
b) at least 20 wt. % sucrose;
c) at least 3 wt. % builder selected from C₁₂ to C₂₂ fatty acids and/or salts thereof,
   the total proportion of starches, in particular broken down and enzymatically modified starches, and sucrose, being below 65 wt. % based on the total weight of the adhesive composition, and the weight ratio of starches, in particular broken down and enzymatically modified starches, to sucrose being less than 0.70.

As a 40 wt. % solution in deionized water (K<1 μScm⁻¹), the dynamic viscosity of the starch can, according to Brookfield, be separately measured in each case using a Brookfield DV2T viscometer at a temperature of 20° C. and at a rotational speed of 20 rpm using spindle 7 for a dynamic viscosity above 50,000 mPas, using spindle 6 for a dynamic viscosity of up to 50,000 mPas and spindle 4 for a dynamic viscosity below 10,000 mPas.

Broken down starch in the context of the present invention is water-soluble starch obtainable from the native starch granule by gelatinization. Gelatinization is an irreversible, usually thermally induced process in which the starch granule is made to swell in the presence of water and the starch transitions into the aqueous phase and a polymeric solution and/or dispersion is formed. Such a broken down starch can be chemically modified or degraded and enzymatically modified, in particular rearranged. In connection with the present invention, a starch is considered sufficiently broken down when, as a 40 wt. % solution in deionized water, its dynamic viscosity is less than 500,000 mPas at 20° C., measured according to Brookfield, and at a rotational speed of 20 rpm using spindle 7 after the gelatinization process. In the context of the present invention, the starch proportion of the adhesive composition according to the invention comprises any polysaccharide based on α-D-glucose comprising amylose and amylopectin components. In addition to enzymatically modified broken down starch proportions, the starch proportion therefore also includes chemically modified and/or chemically degraded broken down starch provided they are present as the aforementioned polysaccharides.

In order to obtain the starch used in the adhesive composition according to the invention, the starch can be broken down and then converted using a glycogen branching enzyme (E.C. 2.4.1.18). Normal starch consists of two components, the virtually linear amylose having α-1,4-glycosidic bonds and the α-1,6-branched amylopectin. Branched enzymes are enzymes which are able to convert the α-1,4-glycosidic bonds present in amylopectin and amylose into α-1,6 bonds and thus create new branching sites. During incubation with broken down starch, the amylose and/or long side chains of the amylopectin are transferred as new α-1,6-glycosidic bonds are formed. This leads to shortening of the average side chain length and to a significant reduction of the ability of the branched molecules to interact. The starch modified by branching enzymes combines a series of functional properties, such as low viscosity at high concentrations, no retrogradation and a transparent solution, with further functional properties, such as a sufficiently high degree of wet tack.

Accordingly, the invention provides the use of a broken down and enzymatically modified starch having a dynamic viscosity of less than 500,000 mPas measured according to Brookfield that is obtained by treatment of starch or starch derivatives with a glycogen branching enzyme (EC 2.4.1.18). The degree of branching can vary and is dependent on the intended application. Typically, the broken down and enzymatically modified starch has a molecular degree of branching of at least 4%, which is therefore preferred. In a preferred embodiment, the broken down and enzymatically modified starch has a molecular degree of branching of at least 5.0% as a constituent of the adhesive composition according to the invention. This provides a highly stable product. The degree of branching in this context is preferably at least 5.5%, and is, for example, in the range from about 5.5 to about 6.5%. The degree of molecular branching as used here refers to the relative amount of α-1,6-glycosidic bonds over the entirety of the α-1,6- and α-1,4-glycosidic bonds ((α-1,6/(α-1,6+α-1,4)*100%) and can be determined by methods known in the art. Typically and therefore preferably, the degree of branching in the context of the present invention does not exceed 8.0%, very particularly preferably does not exceed 7.5%.

Preferably, the starch or the starch derivative is first broken down before it is brought into contact with the branching enzyme. Starch gelatinization, as already mentioned above, is a process in which the intermolecular bonds of the starch molecules are broken open in the presence of water and heat so that the hydrogen bonding sites (the hydroxyl hydrogen and the oxygen) can absorb more water. The starch granule is thereby irreversibly dissolved. The penetration of water increases randomness in the general granulate structure and reduces the number and size of the crystalline regions. The gelatinized starch can be brought to the desired pH by addition of acid or base. After the desired temperature has been reached, the branching enzyme is added and the solution is kept at the desired temperature for a desired time. Alternatively, the branching enzyme can be added to a starch suspension at room temperature and, while stirring, the slurry can be heated to the desired temperature and kept at this temperature for the desired time.

The branching enzyme can originate from any suitable microbial source, it is preferably obtained from a thermostable glycogen branching enzyme obtained from a mesophilic or thermophilic organism. Preferably, the glycogen branching enzyme is Aquifex aeolicus, Anaerobranca gottschalkii or Rhodothermus obamensis.

In the context of the present invention, it has surprisingly been found that no dimensionally stable adhesive compositions can be obtained from compositions that are conventionally described for glue sticks when broken down and modified starch is used, and therefore a limitation of the total proportion of starches and sucrose is indicated. It has thus been found within the context of the present invention that, in order to achieve particularly advantageous properties, in particular with regard to dimensional stability and abrasion resistance, the total proportion of starches in the adhesive composition according to the invention should be kept within strictly defined limits. An embodiment is therefore preferred in which the total proportion of starches, in particular broken down and enzymatically modified starches, and sucrose is below 60 wt. %, but preferably above 40 wt. %, particularly preferably above 45 wt. %, in each case based on the total weight of the adhesive composition.

A glue stick is characterized in particular by a combination of the properties of abrasion resistance, dimensional stability and compressive strength, which, in addition to sufficient adhesive strength, must be coordinated with one another. For this purpose, it was surprisingly found that the desired combination of properties can be achieved in particular when the adhesive composition has starch and sucrose in a weight ratio of less than 0.70. By adapting this weight ratio, it was possible to further improve the properties of the adhesive composition according to the invention, wherein an embodiment is preferred in which the weight ratio of starch, in particular broken down and enzymatically modified starch, to sucrose is less than 0.60, and preferably greater than 0.30. In the case of a weight ratio of greater than 0.70, the required compressive strength and abrasion resistance of the adhesive composition could not be achieved, whereby compressive strength within the context of the present invention as the maximum load measured in parallel with the longitudinal axis during the collapse of the adhesive composition, in stick form, under compressive loading. A decrease in adhesive strength was observed at a weight ratio of less than 0.30.

The starch contained in the adhesive composition according to the invention is characterized by a dynamic viscosity of less than 500,000 mPas. In a preferred embodiment, the dynamic viscosity of the broken down and enzymatically modified starch is below 200,000 mPas, preferably below 100,000 mPas, particularly preferably below 50,000 mPas, but is preferably at least 10,000 mPas, wherein the dynamic viscosity was determined as described above. In the case of a dynamic viscosity below 10,000 mPas, in addition to the longer processing required at low viscosities, an undesired change in color of the adhesive composition was also observed in some cases at elevated temperatures, so that a dynamic viscosity of at least 10,000 mPas is preferred for most applications. In contrast, it has surprisingly been found that, with a dynamic viscosity below 200,000 mPas, gel formation and recrystallization in the adhesive composition is suppressed and a homogeneous and storage-stable adhesive composition is obtained. By further lowering the dynamic viscosity to below 100,000 mPas, preferably below 50,000 mPas, it was possible to significantly improve the pumpability and fillability of the adhesive composition in the liquid and heated state. The viscosity range of 10,000 to 50,000 mPas was identified as a good compromise between the process duration and the energy requirement and the provision of sufficiently degraded starches for sufficient adhesive strength and color stability of the adhesive composition according to the invention. Furthermore, it is ensured in this viscosity range that, for the production of cylindrical adhesive compositions, as are necessary for the provision as glue sticks, fewer rejects as a result of incorrect filling of the stick sleeves and overall less downtimes during filling are achieved.

The starting starch used for the broken down and enzymatically modified starch used in the adhesive composition according to the invention is preferably a starch of natural origin. This natural starch can be any conventional tuber, cereal or leguminous starch, e.g. pea starch, corn starch, incl. waxy corn starch, potato starch, including waxy potato starch, amaranth starch, rice starch, including waxy rice starch, wheat starch, including waxy wheat starch, barley starch, including waxy barley starch, tapioca starch or sago starch. In a preferred embodiment, the broken down and enzymatically modified starch can be obtained from cereals, tubers, roots and/or legumes, preferably can be obtained from tubers, particularly preferably from sweet potatoes and/or potatoes, especially preferably from potatoes.

Starches of natural origin generally have an amylose content of 20% to 40%, depending on the plant species from which they are obtained. This amylose content is also preferred within the context of the present invention. However, there are also amylopectin-rich starches which have a significantly increased amylopectin content or products which contain an increased amylose content. Starches having a high amylopectin content can likewise be broken down and enzymatically degraded in the context of the present invention for adhesive compositions according to the invention, starches having amylopectin contents above 80% also being usable here. Amylopectin is already a branched starch, and the enzymatic modification according to the invention using a branching enzyme can further increase this already natively high branching.

Because starch is naturally heterogeneous, in addition to the starch molecules, other starch molecules having the aforementioned properties can also occur in the range preferred according to the invention in enzymatically branched starches prepared according to the invention for the adhesive composition. In preferred embodiments, the proportion of enzymatically modified starch is at least 65 wt. %, preferably at least 80 wt. %, particularly preferably at least 90 wt. %, based on the total starch proportion.

The adhesive composition according to the invention is characterized in that it is mainly obtained from natural raw materials. An embodiment is therefore preferred in which the proportion of broken down and chemically modified starches, in particular hydroxyalkyl-carboxymethyl-modified starches is, based on the total starch proportion, preferably less than 20 wt. %, particularly preferably less than 10 wt. %, very particularly preferably less than 5 wt. %. The chemically modified starches are in particular those which are obtained as products of the condensation between the hydroxyl groups of the anhydroglucose units (AGE) of starch molecules and alcoholic hydroxyl groups of other compounds. In a particular embodiment, however, at least 0.1 wt. %, preferably at least 1.0 wt. %, but preferably less than 5.0 wt. %, particularly preferably less than 3.0 wt. % of hydroxyalkyl-carboxymethyl-modified starches, in each case based on the total weight of the adhesive composition, can be advantageous in the adhesive composition according to the invention for adjusting the rheological properties for the liquid filling of the adhesive compositions according to the invention in the industrial production of glue sticks.

The builder structure of the adhesive composition according to the invention is made up of C₁₂ to C₂₂ fatty acids and/or salts thereof. In a preferred embodiment, at least 4 wt. %, preferably at least 5 wt. %, but preferably no more than 10 wt. % builders selected from C₁₂ to C₂₂ fatty acids and/or salts thereof are contained in the adhesive composition according to the invention, in each case based on the total weight of the adhesive composition. The builder structure is preferably selected from C₁₄ to C₁₈ fatty acids and/or salts thereof. Particularly preferably, the salts of the builder structure are the sodium or potassium or calcium salts of the corresponding fatty acids or mixtures of these salts.

The adhesive composition according to the invention is water-based. A water-based adhesive composition can be understood within the context of the present invention as meaning an adhesive composition which contains at least 5 wt. % water based on the total weight of the adhesive composition. In a preferred embodiment, the adhesive composition according to the invention contains at least 10 wt. %, preferably at least 15 wt. %, particularly preferably at least 20 wt. %, in particular preferably at least 25 wt. % water based on the total weight of the adhesive composition.

The adhesive composition according to the invention preferably has a pH value of at least 9.0, especially preferably at least 9.5, but preferably not higher than 11.0. The pH value of the adhesive composition can be adjusted by means of conventional alkaline-reacting substances, such as sodium hydroxide, and the pH value is directly determined as a property of the adhesive composition in the liquefied mass at 80° C. by means of a pH-sensitive glass electrode after calibration with standard buffers.

In a particularly preferred embodiment, the adhesive composition according to the invention contains the following constituents:
a) 10-25 wt. % broken down and enzymatically modified starch having a dynamic viscosity of less than 500,000 mPas measured according to Brookfield and obtainable by modifying native starch by means of a glycogen branching enzyme (EC 2.4.1.18);
b) 20-45 wt. % sucrose;
c) 3-10 wt. % builder selected from C₁₂ to C₂₂ fatty acids and/or salts thereof;
d) at least 20 wt. % water;
e) less than 5 wt. % broken down and chemically modified starch; and, where applicable,
f1) at least 0.1 wt. %, preferably at least 1.0 wt. %, but preferably less than 3.0 wt. % hydroxyalkyl-carboxymethyl-modified starch and preferably less than 3 wt. %, particularly preferably less than 1 wt. % broken down and chemically modified starches that do not represent a hydroxyalkyl-carboxymethyl-modified starch; or
f2) less than 3 wt. %, preferably less than 1 wt. %, broken down and chemically modified starches,
   the wt. % specifications being based on the total weight of the adhesive composition in each case.

The adhesive composition according to the invention is particularly suitable for use as a glue stick. The present invention therefore further relates to a glue stick formed from the adhesive composition according to the invention.

The present invention also relates to the use of the glue stick according to the invention for surface-to-surface bonding of substrates, in particular for bonding paper, cardboard and/or plastics to one another.

The present invention will be explained in more detail with reference to the following examples, which should not in any way be considered limiting of the inventive concept.

Table 1 summarizes exemplary formulations, wherein the data specified in wt. % refer to the total weight of the composition. The adhesive compositions obtained were measured, and the results were logged in Table 1.

TABLE 1

| | Comparative | | | | |
|---|---|---|---|---|---|
| | Example | Example 1 | Example 2 | Example 3 | Example 4 |
| Enzymatically modified starch | 20 | 18 | 16 | 16 | 14 |
| Viscosity of enzymatically | 15000-25000 mPas | | | | |
| modified starch (solution 40%) | | | | | |
| C₁₄ fatty acid | 1.9 | 1.9 | 1.9 | 1.9 | 1.9 |
| C₁₆ fatty acid | 3.72 | 3.72 | 3.72 | 3.72 | 3.72 |
| Sucrose | 25 | 30 | 35 | 40 | 40 |
| Sodium hydroxide (50% | 0.2-1.0 | 0.2-1.1 | 0.2-1.2 | 0.2-1.3 | 0.2-1.4 |
| SOLUTION) | | | | | |
| Water | Remainder | Remainder | Remainder | Remainder | Remainder |
| Total proportion of starch and | 45 | 48 | 51 | 56 | 54 |
| sucrose | | | | | |
| Weight ratio of starch:sucrose | 0.80 | 0.60 | 0.46 | 0.40 | 0.35 |
| Abrasion resistance | not acceptable | satisfactory | good | good | good |
| Compressive strength/N | 33 | 65 | 90 | 101 | 96 |
| Strength of adhesion to paper | N/A | very good | very good | very good | very good |
| | | (paper tear) | (paper tear) | (paper tear) | (paper tear) |

The 10 kN Pro Line test device from Zwick Roell is used for measuring the compressive strength.

The adhesive cut off directly above the piston having a length of 30 mm is inserted between two holding pieces; these are disks made of stainless steel having a thickness of approximately 10 mm, which have a circular recess of 3 mm adapted to the relevant stick diameter. The stick provided with the retaining pieces is placed centrally on the test table of the compressive strength tester. The height of the measuring head is adapted to the height of the test part. The measuring head is then moved toward the stick to be tested at a feed rate of 120 mm/min. The highest compressive force achieved provides the compressive strength in N. At a diameter of 21 mm, the compressive strength of a glue stick should be between 60 and 120 N.

As can be seen from the data provided, the adhesive composition according to the invention is characterized in particular by a combination of high compressive strength, good abrasion resistance and high adhesive strength.

What is claimed is:

1. A water-based, dimensionally stable adhesive composition containing, in each case based on the total weight of the adhesive composition,
a) at least 10 wt. % broken down and enzymatically modified starch having a dynamic viscosity of less than 500,000 mPas measured according to Brookfield and obtainable by modifying native starch by means of a glycogen branching enzyme (EC 2.4.1.18);
b) at least 20 wt. % sucrose;
c) at least 3 wt. % builder selected from C₁₂ to C₂₂ fatty acids and/or the salts thereof,
wherein the total proportion of starches, in particular broken down and enzymatically modified starches, and sucrose is below 65 wt. % based on the total weight of the adhesive composition, and the weight ratio of starches, in particular broken down and enzymatically modified starches, to sucrose is less than 0.70.

2. The adhesive composition according to claim 1, characterized in that the total proportion of starches, in particular broken down and enzymatically modified starches, and sucrose is below 60 wt. % based on the total weight of the adhesive composition.

3. The adhesive composition according to claim 1, characterized in that the weight ratio of starch, in particular the broken down and enzymatically modified starch, to sucrose is less than 0.60.

4. The adhesive composition according to claim 1, characterized in that the dynamic viscosity of the broken down and enzymatically modified starch is below 200,000 mPas.

5. The adhesive composition according to claim 1, characterized in that the broken down and enzymatically modified starch can be obtained from cereals, tubers, roots and/or legumes.

6. The adhesive composition according to claim 1, characterized in that the proportion of enzymatically broken down starches is, based on the total starch proportion, at least 65 wt. %.

7. The adhesive composition according to claim 1, characterized in that the proportion of broken down and chemically modified starches based on the total starch proportion.

8. The adhesive composition according to claim 1, characterized in that said adhesive composition contains at least 4 wt. % builders selected from C₁₂ to C₂₂ fatty acids and the salts thereof, based, in each case, on the total weight of the adhesive composition.

9. The adhesive composition according to claim 1, characterized in that the salts of the C₁₂ to C₂₂ fatty acids are selected from sodium, potassium and/or calcium salts.

10. The adhesive composition according to claim 1, characterized in that said adhesive composition contains at least 10 wt. % based on the total weight of the adhesive composition.

11. The adhesive composition according to claim 1, characterized in that the adhesive composition has a pH value of at least 9.0.

12. The adhesive composition according to claim 1, containing
a) 10-25 wt. % broken down and enzymatically modified starch having a dynamic viscosity of less than 500,000 mPas measured according to Brookfield and obtainable by modifying native starch by means of a glycogen branching enzyme (EC 2.4.1.18);
b) 20-45 wt. % sucrose;
c) 3-10 wt. % builder selected from C₁₂ to C₂₂ fatty acids and/or the salts thereof;
d) at least 20 wt. % water; and
e) less than 5 wt. % broken down and chemically modified starch; and,
where applicable,
f1) at least 0.1 wt. % broken down and chemically modified starches which do not represent a hydroxyalkyl-carboxymethyl-modified starch; or
f2) less than 3 wt. % broken down and chemically modified starches, the wt. % specifications being based on the total weight of the adhesive composition in each case.

13. A glue stick formed from an adhesive composition according to claim 1.
